(19) United States
(12) Patent Application Publication
(10) Pub. No.: US 2011/0127016 A1
(43) Pub. Date: Jun. 2, 2011

(54) HEAT EXCHANGER

(75) Inventors: Tobias DÜPMEIER, Paderborn (DE); Torsten HOWE, Bunde (DE); Thorsten ANDRES, Paderborn (DE)

(73) Assignee: Benteler Automobiltechnik GmbH, Paderborn (DE)

(21) Appl. No.: 12/957,642

(22) Filed: Dec. 1, 2010

(30) Foreign Application Priority Data
Dec. 1, 2009 (DE) 102009056274.5-16

(51) Int. Cl. F28F 13/12; B21D 53/02; B23K 26/00

(52) U.S. Cl. 165/109.1; 29/890.03; 219/121.64

(57) ABSTRACT

A heat exchanger includes a housing having first and second longitudinal housing walls disposed in opposite relationship, and plural cartridges which are made from extruded aluminum sections and have channels for flow of a first medium there through. The cartridges are received in the housing in alternating relationship in several rows to thereby define a multiple S-shaped curved flow path for flow of a second medium around the cartridges, with a first longitudinal side of each of the cartridges touching one of the first and second housing walls and with an opposite second longitudinal side thereof positioned at a distance to the other one of the first and second housing walls.

### CROSS-REFERENCES TO RELATED APPLICATIONS

This application claims the priority of German Patent Application, Ser. No. 10 2009 056 274.5-16, filed Dec. 1, 2009, pursuant to 35 U.S.C. 119(a)-(d), the content of which is incorporated herein by reference in its entirety as if fully set forth herein.

### BACKGROUND OF THE INVENTION

The present invention relates, in general, to a heat exchanger.

The following discussion of related art is provided to assist the reader in understanding the advantages of the invention, and is not to be construed as an admission that this related art is prior art to this invention.

German Patent Document DE 10 2007 015 146 A1 describes a heat exchanger having a cylindrical housing made from an extruded aluminum section. Several fastening webs extend in parallel relationship from opposite regions of the inner surface of the housing towards one another. The fastening webs secure cartridges which are provided with channels. Each cartridge has a channel as well as a fastening web and an opposite receiving groove. As a result, several cartridges in a row can be joined to form a matrix and secured in the fastening webs inside the housing. The cartridges are also made from an extruded aluminum sections. The one cartridge which is provided inside the housing in a row on the end opposite to the fastening web can also have only a single receiving groove. There is no fastening web. Flowing in the cartridges is a hot medium to be cooled and in the housing a cooling cold medium.

A heat exchanger of this type can be used for a motor vehicle and installed in the relatively hot exhaust gas system for cooling the exhausts of an internal combustion engine. Another example for use in a motor vehicle involves a heating of the coolant circulation.

A drawback of this conventional heat exchanger is the need to provide a multiplicity of cartridges with fastening webs and receiving grooves for guiding the hot exhausts. The cartridges have first to be pushed into one another in a row in longitudinal direction and connected inside the housing with the fastening webs. It is further required to arrange narrow fastening webs to secure the cartridges inside the housing. Moreover, the individual channels of the cartridges must be connected at their end faces to an exhaust feed and an exhaust discharge, respectively. This complicates manufacture and installation.

It would therefore be desirable and advantageous to provide an improved heat exchanger which obviates prior art shortcomings and is simple in structure while yet being reliable and efficient in operation.

### SUMMARY OF THE INVENTION

According to one aspect of the present invention, a heat exchanger includes a housing having first and second longitudinal housing walls disposed in opposite relationship, and plural cartridges made from extruded aluminum sections and having channels for flow of a first medium there through, with the cartridges being received in the housing in alternating relationship in several rows to thereby define a multiple S-shaped curved flow path for flow of a second medium around the cartridges, with a first longitudinal side of each of the cartridges touching one of the first and second housing walls and with an opposite second longitudinal side thereof positioned at a distance to the other one of the first and second housing walls.

The present invention resolves prior art problems by providing a single cartridge in each row. Neighboring cartridges are received in the housing in transverse offset relationship whereby one longitudinal side contacts a housing wall and the other longitudinal side is spaced from the opposite housing wall. As a result, a multiple S-shaped curved flow path can be realized without the need for guide or baffle plates. The heat exchange becomes highly efficient between the first medium flowing in the channels through the cartridges and the second medium flowing in a serpentine-shaped path around the cartridges.

According to another advantageous feature of the present invention, flange plates can be provided to align the cartridges on opposite end faces of the housing. Suitably, the flange plates may have pocket-shaped depressions for snugly fitting the housing. In other words, the ends of the housing are received in the pocket-shaped depressions of the flange plates and fixed in place by a material joint for example, to effect a snug fit with the flange plates. The material joint may be realized by laser beam welding or soldering. Also gluing is conceivable.

According to another advantageous feature of the present invention, the flange plates may have apertures having a contour conforming to a cross sectional contour of the cartridges. The cartridges engage these apertures of the flange plates to permit a connection of all cartridges with a flange plate when assembling a heat exchanger, and then to install this unitary structure into the housing. Subsequently, the cartridges can be connected with the opposite flange plate which in turn is then connected with the housing.

According to another advantageous feature of the present invention, the cartridges may be sealingly connected with the flange plates. Examples include soldering, laser beam welding, or gluing.

Even though it is conceivable to prevent a flow of the second medium as a result of the contact of the first longitudinal sides of the cartridges with the housing walls in these contact zones, it may be beneficial to provide the housing walls with grooves for positioning the first longitudinal side of the cartridges. The cross sections of the grooves and the first longitudinal sides of the cartridges may be selected randomly, although they have to be suited to one another. Currently preferred are a concave configuration of the grooves and a convex configuration of the first longitudinal sides. The contours of the grooves and the first longitudinal sides can be configured in the form of a circular segment. Of course, oval contours may also be conceivable. The cartridges may optionally be snugly fitted in the grooves.

According to another advantageous feature of the present invention, the first medium flowing through the channels represents the medium to be cooled, whereas the second medium flowing around the cartridges is a coolant. This is especially useful for application of a heat exchanger according to the invention in the motor vehicle sector. The first medium may hereby constitute the hot exhausts generated for example by an internal combustion engine, while the coolant may be cooling water.

According to another advantageous feature of the present invention, each of the cartridges can have a plurality of channels in side-by-side relationship. The objective hereby is a smallest possible counterpressure under high turbulence. This can be realized by providing a small cross section for each individual channel, thereby promoting a turbulent flow of the first medium (exhaust gas), accompanied by a greater cooling action as a consequence of the second medium (cooling water) which flows around the cartridges along the serpentine (S-shaped) flow path.

A further increase of turbulent flow of the first medium in the channels of the cartridges may be attained by providing turbulence-generating devices in the channels of the cartridges. Examples of turbulence-generating devices include protuberances formed on wall portions of the cartridges. The turbulence-generating devices then project into the channels.

Advantageously, the protuberances may have a trapezoidal configuration in longitudinal and transversal directions. The depressions may hereby be shaped in the form of a truncated pyramid.

According to another advantageous feature of the present invention, the turbulence-generating devices can have a longitudinal dimension which is oriented at an angle to the longitudinal extension of the channels.

According to another advantageous feature of the present invention, the turbulence-generating devices of two neighboring channels may be arranged offset to one another in longitudinal direction of the channels.

According to another advantageous feature of the present invention, the turbulence-generating devices may be formed by swirl-inducing insets inserted in the channels in longitudinal direction. An example of such turbulence-generating devices includes helicoidally curved sheet metal strips.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is an end view of a housing of a heat exchanger according to the present invention;

FIG. 2 is an end view of a cartridge for the heat exchanger;

FIG. 3 is a perspective view, partly in cross section, of the cartridge of FIG. 2;

FIG. 4 is a plan view of the cartridge of FIGS. 2 and 3;

FIG. 5 is a perspective view of a turbulence-generating device;

FIG. 6 is an end view of the heat exchanger viewed in a direction of arrow VI in FIG. 8;

FIG. 7 is an end view of the housing of the heat exchanger with inserted cartridges, with flange plates being removed and depiction of a serpentine flow path flowed by the second medium; and

FIG. 8 is a longitudinal section of the heat exchanger of FIG. 6, taken along the line VIII-VIII in FIG. 6 and viewed in a direction of arrows VIIIa.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

Turning now to the drawing, and in particular to FIG. 1, there is shown an end view of a housing, generally designated by reference numeral 1 and forming part of a heat exchanger according to the present invention, shown in greater detail in FIGS. 6 to 8 and generally designated by reference numeral 2. The housing 1 is made from an extruded aluminum section.

In the non-limiting example of FIG. 1, the housing 1 has a rectangular cross section with rounded longitudinal edges 3. The housing 1 has a narrow housing wall 4 with an inlet pipe 5 for supply of a (second) medium 6, e.g. cooling water, and an opposite narrow housing wall 7 with an outlet pipe 8 for the medium 6. The outlet pipe 8 is arranged in diagonal offset relation to the inlet pipe 5. A separate chamber 9 is provided in the lower left-hand corner of the housing 1 and not connected with the interior 10 of the housing 1 for provision of a bypass.

Formed in inner wall surfaces 11 of opposing wide housing walls 12, 13 are concavely shaped grooves 14 in the form of circular segments. FIG. 1 clearly shows that the grooves 14 in the inner wall surface 11 of the housing wall 12 are arranged offset in relation to the grooves 14 in the inner wall surface 11 of the housing wall 13 in a direction of the housing walls 4, 7.

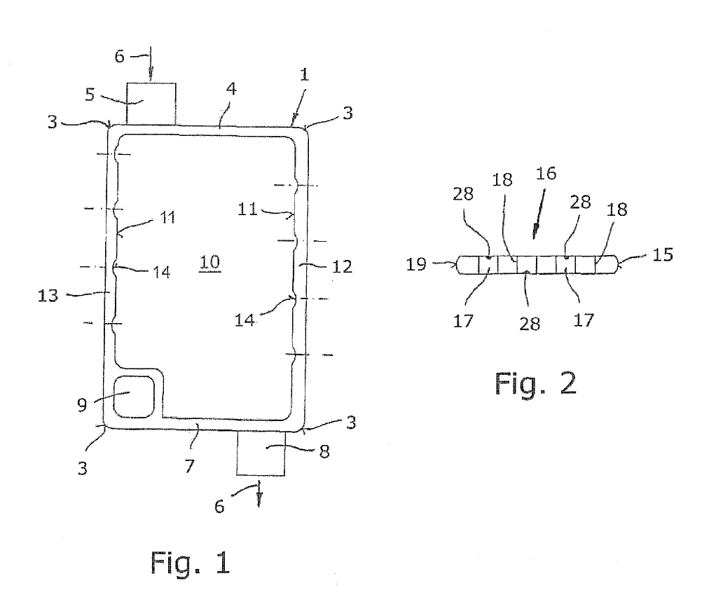

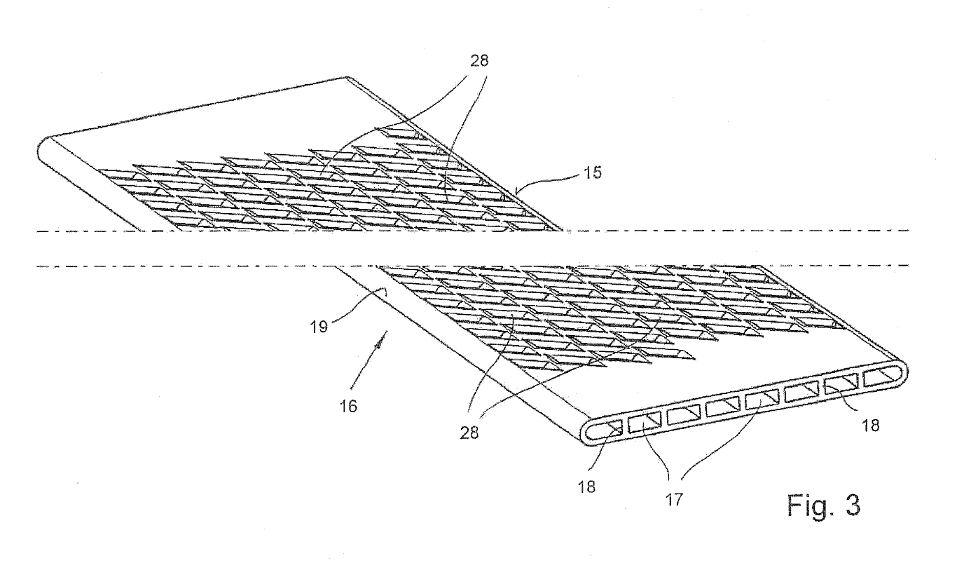

The grooves 14 in the housing walls 12, 13 serve as installation aid and placement of cartridges 16 having first longitudinal sides 15 of a contour conforming to a contour of the grooves 14 and arranged in several rows R next to one another or above one another as shown in FIGS. 6 to 8. As shown in FIGS. 2 and 3, the cartridges 16 are provided with several channels 17 arranged side-by-side and separated from one another by walls 18. The cartridges 16 area also made from extruded aluminum sections.

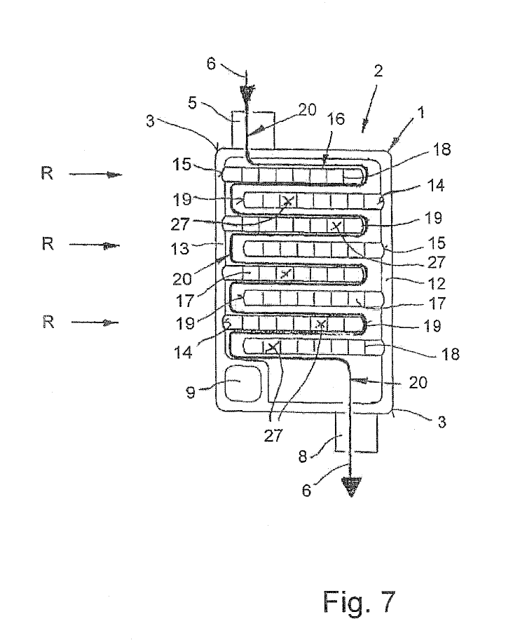

As best seen in FIG. 7, the cartridges 16 are received in the housing 1 in alternating offset relationship in such a way that the first longitudinal sides 15 of the cartridges 16 are positioned in the grooves 14 of the housing walls 12, 13, respectively, and the other second longitudinal sides 19 are spaced at a distance from the opposite housing walls 13, 12. Starting from the inlet pipe 5, a multiple S-shaped curved or serpentine flow path 20 is thus defined for flow of the medium 6 which exits via the outlet pipe 8 of the housing 1.

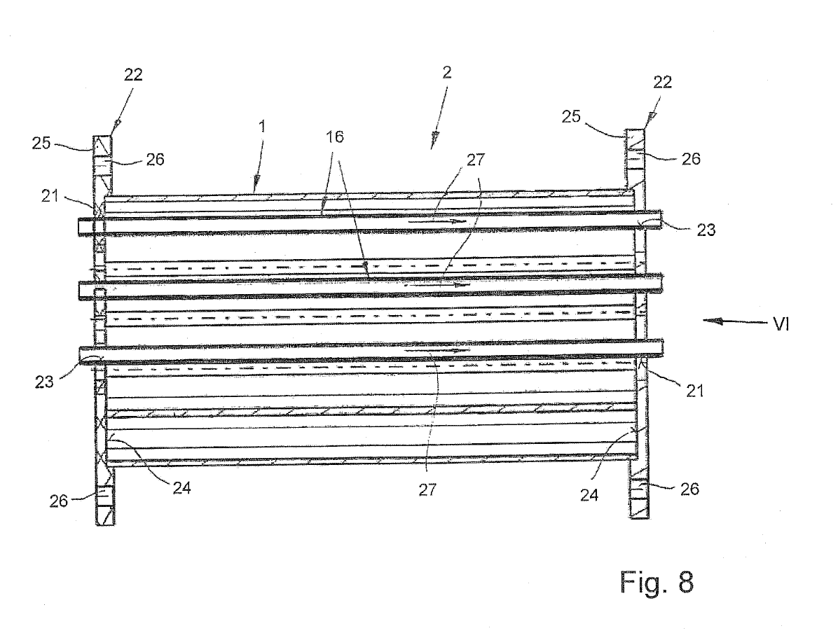

As shown in FIG. 8, the cartridges 16 have ends 21 are aligned in flange plates 22 of aluminum which are provided at the end faces of the housing 1, respectively. FIG. 6 shows an end view of a flange plate 22 which has apertures 23 lying above one another in correspondence to a cross sectional contour of the cartridges 16.

In addition, each flange plate 22 has a pocket-shaped depression 24 (FIG. 8) which conforms to an outer contour of the housing 1 and provided to realize a snug fit of the housing 1. The snug fit of the housing 1 with the flange plates 22 may be implemented by soldering, laser beam welding, or gluing.

Bores 26 are provided in flanges 25 of the flange plates 22 about the circumference of the housing 1 for local securement of the heat exchanger 2.

When the heat exchanger 2 is assembled, the cartridges 16 are placed with one end into the apertures 23 of a flange plate 22 and snugly joined, e.g. by soldering, gluing, or laser beam welding. The thus formed unitary structure of cartridges 16 and flange plate 22 is then joined with the housing 1, with the first longitudinal sides 15 of the cartridges 16 sliding into the grooves 15 in the inner wall surface 11 of the housing walls 12, 13. The housing 1 after being placed in the pocket-shaped depression 24 is then snugly joined in the depression 24 by soldering, laser beam welding, or gluing. Subsequently, the other flange plate 22 is installed via its apertures 23 with the other ends 21 of the cartridges 16 and via its depression 24 with the housing and then snugly joined, e.g. by gluing, soldering, or laser beam welding.

Provided on the sides of the flange plates 22 facing away from the housing 1 are inlet and outlet connections for the (first) medium 27 (medium to be cooled, e.g. exhaust gas), flowing through the channels 17 of the cartridges 1. These connections are not shown in greater detail. The first medium 27 is indicated in FIG. 7 by crosses and in FIG. 8 by arrows.

The channels 17 in the cartridges 16 can be provided with turbulence-generating devices 28 which are shown in greater detail in FIGS. 2 to 4. FIG. 2 illustrates turbulence-generating devices 28 in the form of protuberances extending inwards from wall portions of the cartridges 16 into the channels 17. The number of turbulence-generating devices 28 in the channels 17 or whether turbulence-generating devices 28 are provided in all or only some of channels 17 can be chosen to suit the situation at hand.

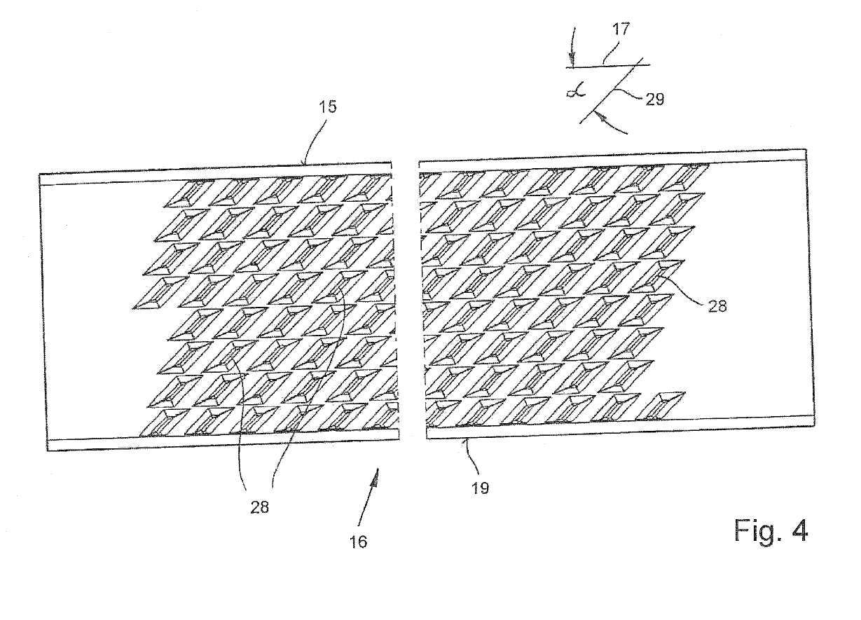

The turbulence-generating devices 28 may also be formed with trapezoidal (truncated pyramid shape) protuberances in longitudinal and transversal sections, as shown in FIGS. 3 and 4. FIG. 4 shows that the turbulence-generating devices 28 can have a longitudinal dimension 29 extending at an angle α in relation to the channels 17. FIG. 4 also illustrates that turbulence-generating devices 28 provided in two neighboring channels 17 can be arranged in offset relation to one another in longitudinal direction of the channels 17.

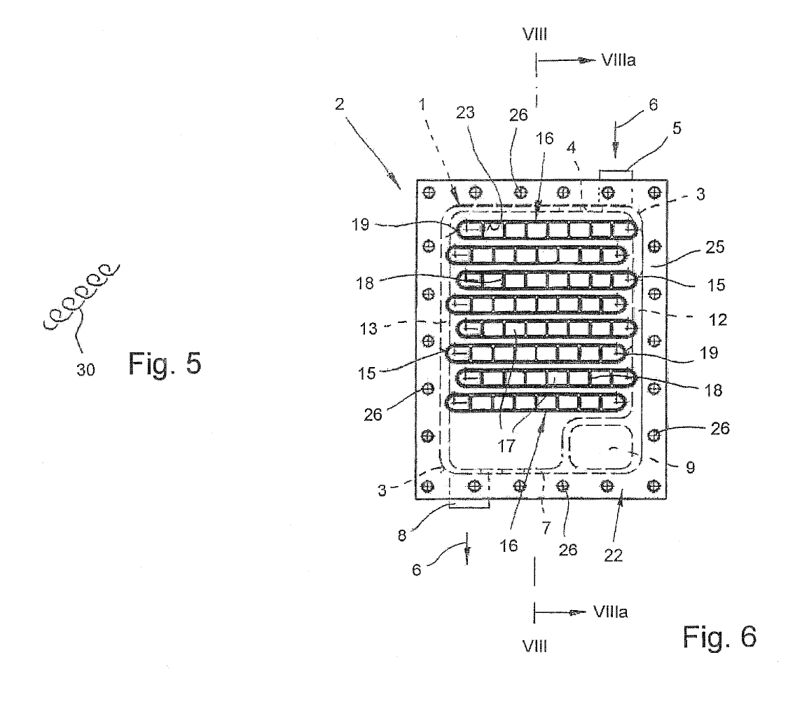

FIG. 5 shows by way of example the provision of turbulence-generating devices 30 in the form of swirl-inducing insets in the shape of helically bent sheet metal strips.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A heat exchanger; comprising:
a housing having first and second longitudinal housing walls disposed in opposite relationship; and
plural cartridges made from extruded aluminum sections and having channels for flow of a first medium there through, said cartridges being received in the housing in alternating relationship in several rows to thereby define a multiple S-shaped curved flow path for flow of a second medium around the cartridges, with a first longitudinal side of each of the cartridges touching one of the first and second housing walls and with an opposite second longitudinal side thereof positioned at a distance to the other one of the first and second housing walls.

2. The heat exchanger of claim 1, further comprising flange plates to align the cartridges on opposite end faces of the housing.

3. The heat exchanger of claim 2, wherein the flange plates have pocket-shaped depressions for snugly fitting the housing.

4. The heat exchanger of claim 2, wherein the flange plates have apertures of a contour conforming to a cross sectional contour of the cartridges.

5. The heat exchanger of claim 2, wherein the cartridges are sealingly connected with the flange plates.

6. The heat exchanger of claim 1, wherein the housing walls have grooves for positioning the first longitudinal side of the cartridges.

7. The heat exchanger of claim 6, wherein the grooves have a concave configuration of the grooves and the first longitudinal sides have a convex configuration.

8. The heat exchanger of claim 1, wherein the first medium flowing through the channels is to be cooled, whereas the second medium flowing around the cartridges is a coolant.

9. The heat exchanger of claim 1, wherein each of the cartridges has a plurality of channels in side-by-side relationship.

10. The heat exchanger of claim 1, further comprising turbulence-generating devices provided in the channels of the cartridges.

11. The heat exchanger of claim 10, wherein the turbulence-generating devices are formed by protuberances on wall portions of the cartridges.

12. The heat exchanger of claim 11, wherein the protuberances have a trapezoidal configuration in longitudinal and transversal directions.

13. The heat exchanger of claim 10, wherein the turbulence-generating devices have a longitudinal dimension oriented at an angle to the channels.

14. The heat exchanger of claim 10, wherein the turbulence-generating devices of two neighboring channels are arranged offset to one another in longitudinal direction of the channels.

15. The heat exchanger of claim 10, wherein the turbulence-generating devices are formed by swirl-inducing insets inserted in the channels in longitudinal direction.

16. The heat exchanger of claim 10, wherein the turbulence-generating devices are formed by helicoidally curved sheet metal strips.

17. A method of making a heat exchanger, comprising the steps of:
inserting first ends of a plurality of cartridges in complementary apertures of a first flange plate to form a unitary structure, wherein the apertures are formed in the flange plate in alternating offset relationship;
placing the unitary structure in a housing;
inserting second ends of the cartridges in complementary apertures of a second flange plate placed in opposition to the first flange plate; and
joining the second flange plate to the housing.

18. The method of claim 17, wherein the joining step includes a material joint selected from the group consisting of laser beam welding, soldering, and gluing.
